(19) United States
(12) Patent Application Publication
(10) Pub. No.: US 2026/0194346 A1
(43) Pub. Date: Jul. 9, 2026

(54) METHOD FOR OPERATING A SENSOR SYSTEM AND SENSOR SYSTEM

(71) Applicant: Robert Bosch GmbH, Stuttgart (DE)

(72) Inventor: Kaushik Krishna Rangharajan, Pforzheim (DE)

(21) Appl. No.: 19/432,395

(22) Filed: Dec. 24, 2025

(30) Foreign Application Priority Data
Jan. 9, 2025 (DE) 10 2025 100 518.4

(51) Int. Cl. G01C 5/06; G01C 19/5712

(52) U.S. Cl. CPC G01C 5/06; G01C 19/5712

(57) ABSTRACT

A computer-implemented method for operating a sensor system having at least one MEMS gyroscope and at least one pressure sensor. The method includes: receiving pressure sensor data from the at least one pressure sensor, wherein the pressure sensor data represent an ambient pressure of an environment of the sensor system; ascertaining a pressure change in the ambient pressure based on the pressure sensor data, wherein the pressure change comprises a predefined change profile; ascertaining, based on the pressure change with the predefined change profile of the ambient pressure, that the sensor system is in a falling state; and interrupting actuation of the MEMS gyroscope. A sensor system is also described.

### CROSS REFERENCE

The present application claims the benefit under 35 U.S.C. § 119 of Germany Patent Application No. DE 10 2025 100 518.4 filed on Jan. 9, 2025, which is expressly incorporated herein by reference in its entirety.

### FIELD

The present invention relates to a method for operating a sensor system and to a sensor system.

### BACKGROUND INFORMATION

Sensor systems, in particular MEMS gyroscopes, are described in the related art. When a MEMS gyroscope is dropped, damage may occur during operation of the MEMS gyroscope.

### SUMMARY

An object of the present invention to provide an improved method for operating a sensor system and an improved sensor system.

This object may be achieved by the method and the sensor system having certain features of the present invention. Advantageous example embodiments of the present invention are disclosed herein.

According to one aspect of the present invention, a computer-implemented method for operating a sensor system having at least one MEMS gyroscope and at least one pressure sensor is provided. According to an example embodiment of the present invention, the method comprises:
Receiving pressure sensor data from the at least one pressure sensor, wherein the pressure sensor data represent an ambient pressure of an environment of the sensor system;
Ascertaining a pressure change in the ambient pressure based on pressure sensor data, wherein the pressure change comprises a predefined change profile;
Ascertaining, based on the pressure change with the predefined change profile of the ambient pressure, that the sensor system is in a falling state; and
Interrupting actuation of the MEMS gyroscope.

This can achieve the technical advantage that an improved method for operating a sensor system comprising at least one MEMS gyroscope and at least one pressure sensor can be provided. For this purpose, pressure sensor data from the at least one pressure sensor are initially received, which represent the ambient pressure of an environment of the sensor system. Based on the pressure sensor data, a pressure change according to a predefined change profile is ascertained.

The pressure change according to the predefined change profile is interpreted as meaning that the sensor system is in free fall. Based on this, the actuation of the MEMS gyroscope is interrupted. Using the pressure sensor data from the pressure sensor, a falling movement of the sensor system can thus be ascertained with precision. When the falling movement of the sensor system is ascertained, the actuation of the MEMS gyroscope is interrupted.

This has the advantage that, upon impact of the sensor system on a surface, damage to the MEMS gyroscope can be prevented or reduced. However, if the MEMS gyroscope continues to be actuated during the impact, this can lead to damage to the oscillation element of the MEMS gyroscope due to the impact vibrations.

Here, in particular individual pieces or portions of the oscillation element of the MEMS gyroscope can become detached. During further operation of the MEMS gyroscope, these portions can lead to electrical short circuits and associated static/dynamic shifts of an offset of the MEMS gyroscope, or to measurement errors and inaccuracies of the MEMS gyroscope. Such defects can be reduced by interrupting the actuation of the MEMS gyroscope.

The actuation of the MEMS gyroscope, within the meaning of the application, comprises in particular driving the oscillation element of the MEMS gyroscope to perform an oscillatory movement.

According to one example embodiment of the present invention, the predefined change profile is an exponential pressure increase of the ambient pressure, and/or wherein the pressure change is ascertained based on absolute pressure values and/or based on pressure gradient values.

This can achieve the technical advantage that, due to the predefined change profile of the pressure change, in the form of an exponential pressure increase of the ambient pressure, a falling movement of the sensor system can be precisely ascertained. By ascertaining the pressure change based on absolute pressure values based on pressure gradient values, the most precise and error-resistant ascertaining of the pressure change and, based on this, the falling movement of the sensor system can be achieved.

According to one example embodiment of the present invention, the method further comprises:
Ascertaining, based on the pressure sensor data, that the pressure change in the ambient pressure no longer occurs according to the predefined change profile;
Ascertaining that the fall of the sensor system has been terminated, based on the pressure change not corresponding to the predefined change profile; and
Restarting the actuation of the MEMS gyroscope.

This can achieve the technical advantage that, upon ascertaining a termination of the falling movement of the sensor system, the actuation of the MEMS gyroscope can be resumed. Here, the termination of the falling movement is interpreted as a pressure change that occurs according to a change profile that deviates from the predefined change profile. The termination of the falling movement is recognized when there is a pressure change that does not correspond to, for example, the exponential increase. The sensor system can thus be put back into operation after the falling movement has been terminated.

According to one example embodiment of the present invention, interrupting the actuation of the MEMS gyroscope comprises interrupting an oscillation of an oscillation element of the MEMS gyroscope, and/or wherein restarting the actuation of the MEMS gyroscope comprises exciting the oscillation of the oscillation element of the MEMS gyroscope.

This can achieve the technical advantage that a precise interruption of the actuation of the MEMS gyroscope is effected. For this purpose, an oscillation of the oscillation element of the MEMS gyroscope is interrupted. Accordingly, when the actuation of the MEMS gyroscope is restarted, the oscillation of the oscillation element is excited accordingly. As already mentioned, the oscillation of the oscillation element is the crucial factor that must be suppressed when the falling movement is recognized, in order in this way to minimize or avoid damage to the MEMS gyroscope when the sensor system impacts a surface.

According to one example embodiment of the present invention, interrupting the actuation of the MEMS gyroscope comprises:
Reducing an oscillation amplitude of the oscillation of the oscillation element to a minimum amplitude value by reducing drive signals from an actuator of the MEMS gyroscope used to drive the oscillation of the oscillation element, by reducing a gain value of an operational amplifier of a control loop of the actuator to a minimum gain value; and
After a predefined waiting time has expired, switching off the actuator of the MEMS gyroscope and causing a natural decrease in the remaining oscillation amplitude of the oscillation of the oscillation element of the MEMS gyroscope, and/or wherein the predefined waiting time is dependent on a duration of time that is required to reduce the oscillation amplitude to the minimum amplitude value.

This can achieve the technical advantage that a precise interruption of the actuation of the MEMS gyroscope can be effected. For this purpose, an oscillation amplitude of the oscillation of the oscillation element is reduced to a minimum amplitude value, and after a predefined waiting time has elapsed, the actuator used to excite the oscillation of the oscillation is completely switched off. This can achieve a substantially faster decay of the oscillatory movement of the oscillation element than if merely the active drive of the oscillatory movement were to be terminated.

Here, the reduction of the oscillation amplitude can be effected by reducing drive signals for driving the oscillatory movement.

These can in turn be reduced by reducing a gain value of an operational amplifier of a control loop of the MEMS gyroscope to a minimum value. This allows a rapid and efficient reduction of the oscillation amplitude to a minimum amplitude value and a corresponding rapid deceleration of the oscillatory movement of the oscillation element.

Here, reducing the oscillation amplitude to a minimum amplitude value can be achieved within a range of microseconds. Here, the stated waiting time can also be in the range of microseconds.
According to one example embodiment of the present invention, interrupting the actuation of the MEMS gyroscope comprises: Inverting an oscillation direction of the oscillation of the oscillation element of the MEMS gyroscope by 180° by inverting the drive signals from the actuator using a phase comparator of the control loop of the actuator of the MEMS gyroscope; and
After a predefined waiting time has expired, switching off the actuator of the MEMS gyroscope, and/or wherein the predefined waiting time is dependent on a duration of time that is required to invert the phase of the oscillation of the oscillation element.

This can achieve the technical advantage that, in turn, a precise interruption of the actuation of the MEMS gyroscope can be effected. For this purpose, an oscillation direction of the oscillation of the oscillation element is inverted by 180° and, after waiting for a predefined waiting time, the actuator is completely switched off. Here, inverting the oscillation direction of the oscillation element can be effected by inverting the polarization of the drive signals. This can in turn be effected by a phase inverter of the control loop of the MEMS gyroscope.

By inverting the oscillatory movement by 180° and subsequently switching off the actuator, thereby preventing the active drive for the oscillation of the oscillation element, a rapid deceleration of the oscillatory movement of the oscillation element can in turn be effected. Here, the inversion of the oscillatory movement and the corresponding deceleration of the oscillatory movement can in turn be effected in the millisecond range. This can effect a correspondingly rapid interruption of the actuation of the MEMS gyroscope and a corresponding deceleration of the oscillatory movement of the oscillation element.

According to one example embodiment of the present invention, inverting the phase of the oscillation of the oscillation element of the MEMS gyroscope from 0° to 180° is effected by integrating an inversion bit into a register of the phase comparator.

This can achieve the technical advantage that a correspondingly technically simple inversion of the oscillatory movement direction of the oscillation element can be effected.

According to one aspect of the present invention, a computing unit is provided that is configured to carry out the method for operating a sensor system according to one of the above-described embodiments.

According to one aspect of the present invention, a computer program product is provided, comprising commands that, when the program is executed by a data processing unit, cause the data processing unit to carry out the method for operating a sensor system according to one of the above-described embodiments.

According to one aspect of the present invention, a sensor system is provided having at least one pressure sensor, at least one MEMS gyroscope and at least one computing unit according to the present invention.

Example embodiments of the present invention are described with reference to the figures.

### BRIEF DESCRIPTION OF THE DRAWINGS

FIG. 1 is a schematic representation of a sensor system according to one example embodiment of the present invention.

FIG. 2 is a graphical representation of pressure profiles.

FIG. 3 is a further schematic representation of the sensor system according to a further example embodiment of the present invention.

FIG. 4 is a further schematic representation of the sensor system according to a further example embodiment of the present invention.

FIG. 5 shows a temporal profile of an electrode potential of the sensor system according to a further example embodiment of the present invention.

FIG. 6 is a flowchart of a method for operating a sensor system according to one example embodiment of the present invention.

FIG. 7 is a further flowchart of the method for operating a sensor system according to a further example embodiment of the present invention.

FIG. 8 is a schematic representation of a computer program product, according to an example embodiment of the present invention.

### DETAILED DESCRIPTION OF EXAMPLE EMBODIMENTS

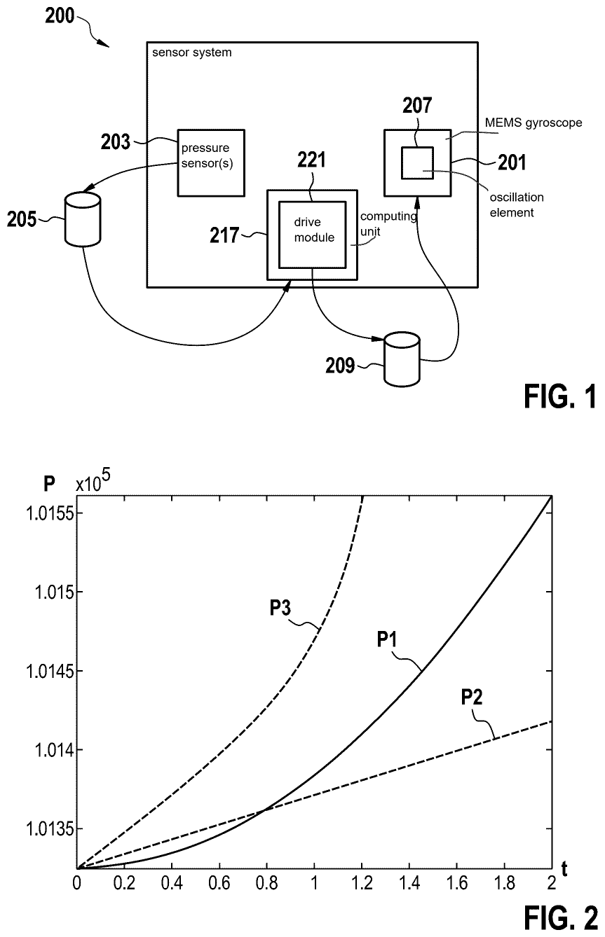

FIG. 1 is a schematic representation of a sensor system 100 according to one embodiment.

According to the invention, the sensor system 200 comprises a MEMS gyroscope 201 and at least one pressure sensor 203.

In the embodiment shown, the sensor system 200 further comprises a computing unit 217 on which a drive module 221 can be executed.

In the embodiment shown, the drive module 221 initially receives the pressure sensor data 205 from the pressure sensor 203. Here, the pressure sensor data 205 represent the ambient pressure of the sensor system 200.

If a pressure change in the ambient pressure is ascertained, based on the pressure sensor data 205, that corresponds to a predefined change profile, the corresponding pressure change is interpreted as meaning that the sensor system 200 is in a falling movement.

If the falling movement of the sensor system 200 is recognized based on the ascertained pressure change in the ambient pressure, the actuation of the MEMS gyroscope 201 is interrupted.

In the embodiment shown, the MEMS gyroscope 201 comprises an oscillation element 207. According to one embodiment, interrupting the actuation of the MEMS gyroscope 201 comprises interrupting the oscillatory movement of the oscillation element 207.

According to one embodiment, in order to interrupt the oscillatory movement of the oscillation element 207, an oscillation amplitude of the oscillatory movement can be reduced to a minimum amplitude value.

According to a further embodiment, in order to interrupt the oscillatory movement of the oscillation element 207, an oscillation direction of the oscillatory movement of the oscillation element 207 can be inverted.

According to one embodiment, the actuation of the oscillation element 201 is resumed if, based on the pressure sensor data 205 from the pressure sensor 203, a pressure change in the ambient pressure is ascertained which is effected according to a change profile that deviates from the predefined change profile. A pressure change according to such a deviating change profile is interpreted as the termination of the falling movement of the sensor system 200. Upon recognition of the termination of the falling movement of the sensor system 200, the actuation of the MEMS gyroscope 201 is thus resumed accordingly.

According to one embodiment, restarting the actuation of the MEMS gyroscope comprises exciting the oscillation of the oscillation element 207.

The actuation of the MEMS gyroscope 201 corresponds to drive signals 219 transmitted to the MEMS gyroscope 201 by the drive module 221. The drive signals 219 can in particular be configured as corresponding potential values for providing an electrostatic drive of the MEMS gyroscope 201.

FIG. 2 is a graphical representation of pressure profiles.

FIG. 2 shows three different pressure changes in the ambient pressure P over time t. The graph shown depicts a pressure change according to the predefined change profile P1, which change is represented by the solid curve. Furthermore, FIG. 2 shows two pressure changes according to deviating change profiles P2, P3, which are in each case represented by the dashed curves.

In the embodiment shown, the predefined change profile P1 corresponds to an exponential pressure increase of the ambient pressure P.

According to the explanations described below, an exponential pressure increase according to the shown predefined change profile P1 of the ambient pressure P can be interpreted as a free fall of the particular pressure sensor 203 or the sensor system 200.

When a corresponding pressure change in the ambient pressure P is ascertained based on the pressure sensor values 205 from the pressure sensor 203, which change proceeds in accordance with the predefined change profile P1 and thus represents an exponential pressure increase, the falling movement of the sensor system 200 is recognized. Based on this, the actuation of the MEMS gyroscope 201 is interrupted.

The two deviating change profiles P2, P3 show, on the one hand, a linear pressure increase P2 and, on the other hand, a more pronounced pressure increase P3 that deviates from the purely exponential pressure increase. The linear pressure increase P2 does not correspond to the free fall, or a falling movement, of the particular pressure sensor 203 or the sensor system 200. The pressure change in the deviating change profile P3 also does not correspond to a free falling movement of the particular pressure sensor 203, but rather shows an externally influenced fall or an externally caused downward movement of the particular pressure sensor 201.

In both cases where a pressure change according to a deviating change profile P2, P3 is ascertained, this is interpreted as a termination of the previously recognized falling movement of the pressure sensor 203 or the sensor system 200. In such a case, the actuation of the MEMS gyroscope 201 can be resumed.

The change profiles P2, P3 shown by way of example in FIG. 2 are merely exemplary and are not intended to limit the present invention.

Deviating from the predefined change profile P1, which is defined in FIG. 2 as an exponential pressure increase, another change profile can also be predefined for recognizing the falling movement.

$$P ( h ) = {P}_{ref} {e}^{\frac{- {g}_{0} M ( h - {h}_{ref} )}{{RT}_{b}}}$$

These are:
P_{ref}—a reference pressure. This could be calibrated to indicate an operating level.
T_{b}—a reference temperature
h_{ref}—a reference height
R—the universal gas constant: 8.3144 J/(mol·K)
g₀—the acceleration due to gravity: 9.8066 m/s²
M—the molar mass of the Earth's atmosphere: 0.02896 kg/mol

For discussion purposes, it can be assumed that P_{ref}=1.01325×105 Pa (standard atmospheric pressure at sea level) at a reference height of 0 m (operating level). During free fall, the atmospheric ambient pressure detected by the pressure sensor 203 increases, i.e., during free fall, h in the formula above has a negative value. For an object that starts at rest, the distance h traveled in free fall is calculated as a function of time as follows:

$$h ( t ) = {h}_{ref} - \frac{{g}_{0 {t}_{free - fall}^{2}}}{2}$$

Substituting this into the formula above yields:

$$P ( t ) = {P}_{ref} {e}^{\frac{{g}_{0}^{2} {Mt}_{free fall}^{2}}{2 {RT}_{b}}}$$

For discussion purposes, it can be assumed that the pressure sensor 203 operates at an ODR of 200 Hz. This means that new filtered data is available every 5 ms. An increase of the ODR in conjunction with an appropriate signal-to-noise ratio can improve early recognition.

The table below shows both (a) the time (t_{free-fall}) elapsed in free fall as well as (b) the distance (h) traveled by the sensor system 100 in free fall before the fall recognition is recognized.

TABLE 1
Distance in free fall according to the ODR of the
pressure sensor and the expected pressure increase

| Elapsed time | Distance traveled | |
|---|---|---|
| [ms] | [cm] | Pressure change ΔP [Pa] |
| 5 | 0.012 | p(5 ms) − p(0 ms) = 0.0015 |
| 10 | 0.049 | =0.0044 |
| 20 | 0.196 | =0.0177 |
| 40 | 0.784 | =0.0707 |
| 80 | 3.138 | =0.2827 |
| 160 | 12.552 | =1.1308 |
| 320 | 50.2908 | =4.5232 |

Given the differences in the gravitational constant and the density of the air, it can be assumed that the relative pressure change during a fall of 50 cm is in the range of 4 to 6 Pa. Instead of the absolute pressure values of the ambient pressure P, pressure gradient values can be taken into account to ascertain the pressure changes and on this basis to recognize the fall of the sensor system 200.

A pressure increase that progresses exponentially over time, corresponding to the predefined change profile P1 of the ambient pressure P, can then be equated with a fall, in particular a free fall, of the sensor system 100.

In contrast, a gradual linear increase or a strongly nonlinear pressure change, as is characterized in FIG. 2 as the deviating change profile P2, P3 of the pressure change in the ambient pressure P, cannot be equated with a free fall of the sensor system 200.

Instead, such a pressure change in the ambient pressure P of the sensor system 200 can be interpreted as meaning that the fall of the sensor system 200 is complete. The completion of the fall of the sensor system 200 can, for example, end with an impact on a surface, thereby decelerating the falling movement of the sensor system 200.

Once the fall of the sensor system 200 has been terminated, the actuation of the MEMS gyroscope 201 can be restarted.

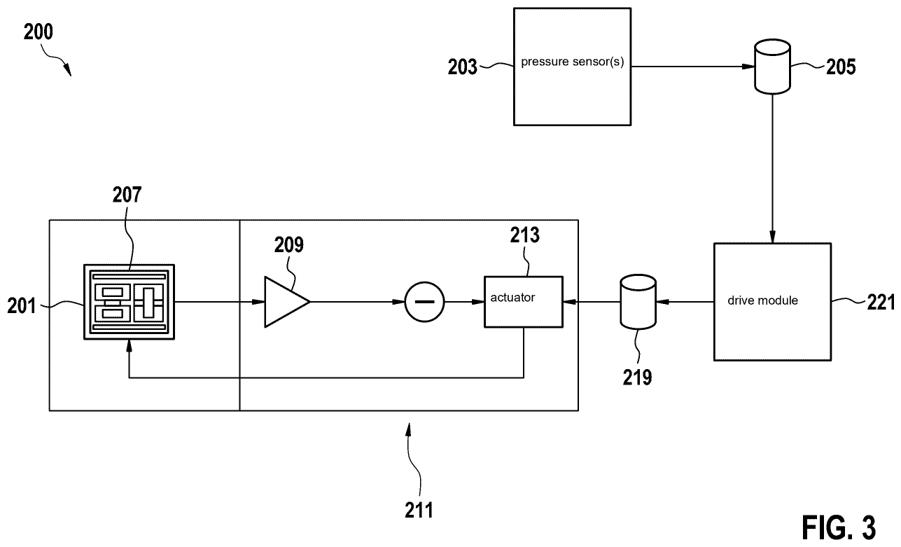

FIG. 3 is a further schematic representation of the sensor system 200 according to a further embodiment.

In the embodiment shown, the MEMS gyroscope 201 with the integrated oscillation element 207 is integrated into a control loop 211. The control loop 211 comprises at least one operational amplifier 209 and an actuator 213. Here, the actuator 213 is configured to transmit the drive signals 219 to the MEMS gyroscope 201. Here, the drive signals 219 can comprise corresponding potential values by means of which electrostatic drive of the oscillation element 207 can be effected to execute the desired oscillatory movement.

In the embodiment shown, an oscillation amplitude of the oscillatory movement of the oscillation element 207 can be reduced to a minimum amplitude value in order to interrupt the drive of the MEMS gyroscope 201. For this purpose, the drive signals 219 from the actuator 213, i.e., the provided potential values, can be reduced accordingly in order in this way to reduce the oscillation amplitudes of the oscillatory movement of the oscillation element 207 to the minimum amplitude value.

In order to reduce the potential values provided by the actuator 213, a gain value of the operational amplifier 209 can be reduced to a minimum gain value. By reducing the gain value of the operational amplifier 209, the potential values provided by the actuator 213 can be automatically reduced accordingly. This consequently allows the precise reduction of the oscillation amplitude of the oscillatory movement of the oscillation element 207.

Such a reduction in the oscillation amplitude of the oscillatory movement can be effected, for example, within a range of microseconds in the single digits to microseconds in the double digits.

In order to interrupt the MEMS gyroscope 201, after a predefined waiting time has elapsed, the actuator 213 can be completely switched off. By switching off the actuator 213, no further drive signals, i.e., no further potential values, are transmitted to the MEMS gyroscope 201. This results in a natural decay of the oscillation amplitude of the oscillatory movement of the oscillation element through a natural braking movement within the MEMS gyroscope 201.

Here, the waiting time can be in the range of microseconds in the single digits.

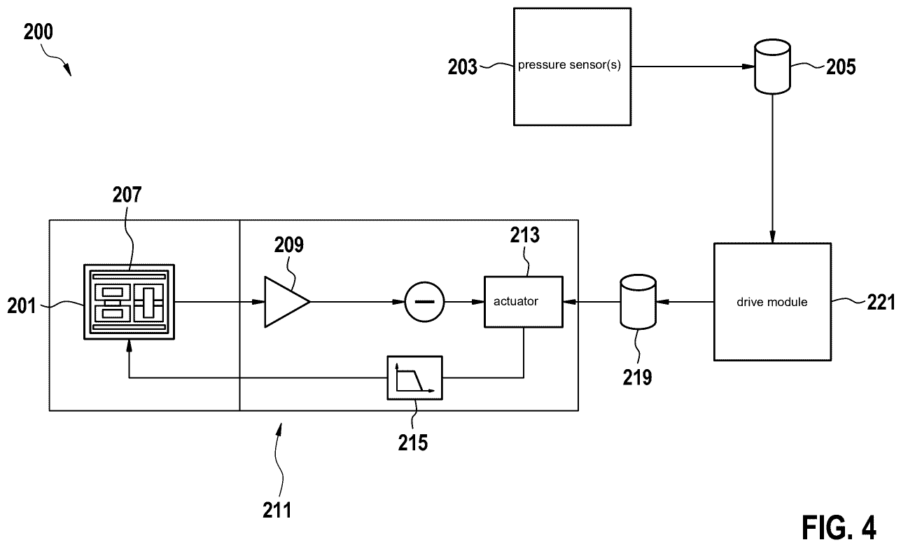

FIG. 4 is a further schematic representation of the sensor system 200 according to a further embodiment.

The embodiment of FIG. 4 is based on the embodiment of FIG. 3 and comprises all the features described there. In the embodiment shown, the control loop 2111 also comprises a phase comparator 215.

In the embodiment shown, in order to interrupt the actuation of the MEMS gyroscope 201, an inversion of an oscillatory movement direction of the oscillatory movement of the oscillation element 207 by 180° degrees is effected. For this purpose, the polarization of the drive signals, i.e., the potential values provided to the MEMS gyroscope 201 by the actuator 213, can be inverted using the phase comparator 215.

After inverting the movement direction of the oscillatory movement of the oscillation element 207, and after a predefined waiting time has elapsed, the actuator 213 can in turn be completely switched off.

Here, inverting the movement direction of the oscillatory movement can in turn be effected in the range of microseconds.

By switching off the actuator 213, it is ensured that no further potential values are transmitted to the MEMS gyroscope 201 by the actuator 213 and thus that the oscillatory movement of the oscillation element 207 is resumed.

Inverting the movement direction of the oscillatory movement by inverting the polarization of the potential values provided by the actuator 213 can, for example, be effected by integrating an inversion bit into a register of the phase comparator 215.

In order to restart the actuation of the MEMS gyroscope 201, the actuator 213 is switched on again, whereupon the actuator 213 again provides corresponding drive signals in the form of corresponding potential values to the MEMS gyroscope 201, based on which the oscillatory movement of the oscillation element 207 is excited again.

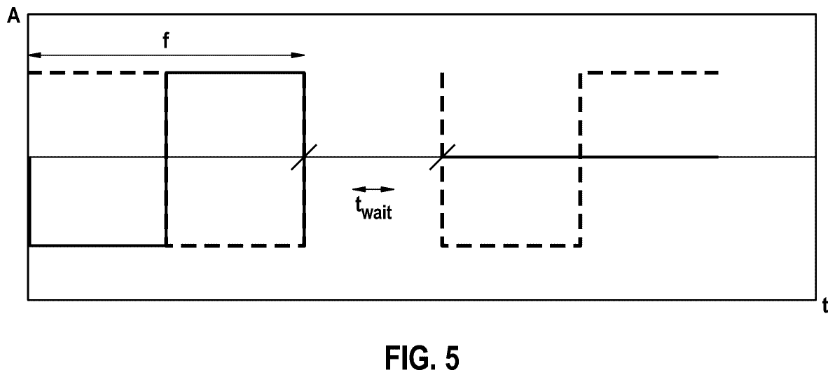

FIG. 5 shows a temporal profile of an electrode potential A of the sensor system 100 according to a further embodiment.

FIG. 5 shows an inversion of the polarization direction of the potential values A of the actuator 213, including a switching-off of the actuator 213 after the predefined waiting time t_{wait} has elapsed. Here, the inverted signal is represented by the solid signal profile.

FIG. 5 also shows a non-inverted signal profile for comparison.

This is represented by the dashed line.

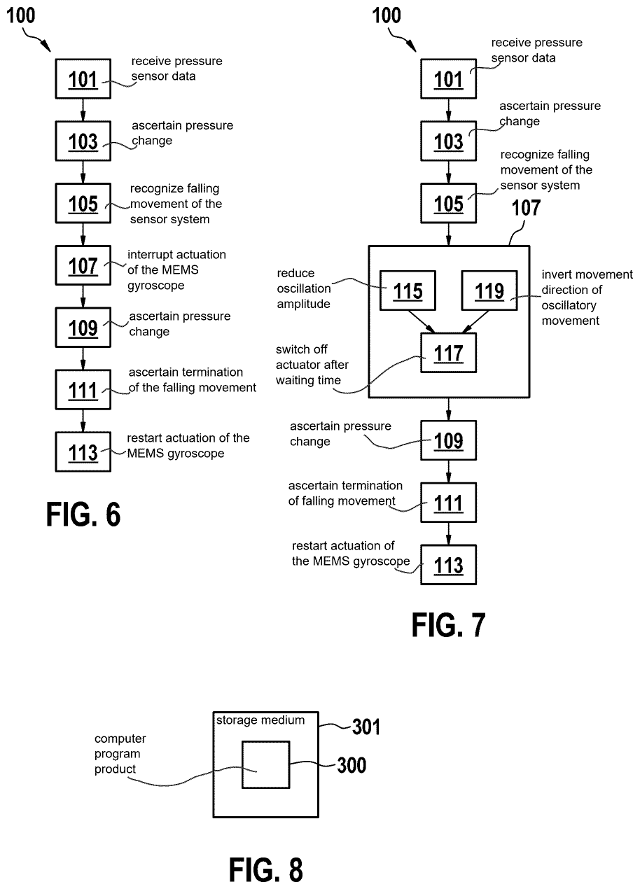

FIG. 6 is a flowchart of a method 100 for operating a sensor system 200 according to one embodiment.

In order to operate the sensor system 200, in a first method step 101, the pressure sensor data 205 from the pressure sensor 203 are initially received, which represent the ambient pressure P of the environment of the sensor system 200.

In a method step 103, the pressure change in the ambient pressure P is ascertained. In particular, it is ascertained that the pressure change occurs according to the predefined change profile P1.

In a further method step 105, the falling movement of the sensor system 200 is recognized based on the pressure change in the ambient pressure P that progresses according to the predefined change profile P1.

In a further method step 107, after ascertaining the falling movement of the sensor system 100, the actuation of the MEMS gyroscope 201 is interrupted.

In a further method step 109, a pressure change in the ambient pressure P is subsequently ascertained, which change occurs according to the change profile P2, P3 that deviates from the predefined change profile.

In a further method step 111, the termination of the falling movement of the sensor system 200 is ascertained based on the pressure change that progresses according to the deviating change profile P2, P3.

In a further method step 113, the actuation of the MEMS gyroscope 201 is restarted based on the edge termination of the falling movement of the sensor system 200.

FIG. 7 is a further flowchart of the method 100 for operating a sensor system 200 according to a further embodiment.

The embodiment in FIG. 7 is based on the embodiment in FIG. 6 and comprises all the method steps described there.

In the embodiment shown, according to the method step 115 for interrupting the actuation of the MEMS gyroscope 201, the oscillation amplitude of the oscillatory movement of the oscillation element 207 is reduced to a minimum amplitude value.

Alternatively or additionally, in a method step 119, the movement direction of the oscillatory movement of the oscillation element 207 is inverted by 180°.

In a further method step 117, after the predefined waiting time t_{wait} has elapsed, the actuator 213 is switched off.

FIG. 8 is a schematic representation of a computer program product 300, comprising commands that, when the program is executed by a data processing unit, cause the data processing unit to carry out the method 100 for operating a sensor system 200.

In the embodiment shown, the computer program product 300 is stored on a storage medium 301. Here, the storage medium 301 can be any storage medium from the related art.

What is claimed is:

1. A computer-implemented method for operating a sensor system including at least one MEMS gyroscope and at least one pressure sensor, the method comprising the following steps:
receiving pressure sensor data from the at least one pressure sensor, wherein the pressure sensor data represent an ambient pressure of an environment of the sensor system;
ascertaining a pressure change in the ambient pressure based on the pressure sensor data, wherein the pressure change includes a predefined change profile;
ascertaining, based on the pressure change with the predefined change profile of the ambient pressure, that the sensor system is in a falling state; and
interrupting actuation of the at least one MEMS gyroscope.

2. The method according to claim 1, wherein: (i) the predefined change profile is an exponential pressure increase of the ambient pressure, and/or (ii) the pressure change is ascertained based on absolute pressure values and/or based on pressure gradient values.

3. The method according to claim 2, further comprising:
ascertaining a pressure change in the ambient pressure that deviates from the predefined change profile;
ascertaining a termination of the fall of the sensor system based on the pressure change not corresponding to the predefined change profile; and
restarting the actuation of the at least one MEMS gyroscope.

4. The method according to claim 3, wherein: (i) the interrupting of the actuation of the at least one MEMS gyroscope includes interrupting driving of an oscillation of an oscillation element of the at least one MEMS gyroscope, and/or (ii) the restarting of the actuation of the at least one MEMS gyroscope includes exciting the oscillation of the oscillation element of the at least one MEMS gyroscope.

5. The method according to claim 1, wherein the interrupting of the actuation of the at least one MEMS gyroscope includes:
reducing an oscillation amplitude of oscillation of an oscillation element of the at least one MEMS gyroscope to a minimum amplitude value by reducing drive signals from an actuator of the MEMS gyroscope used to drive the oscillation of the oscillation element, by reducing a gain value of an operational amplifier of a control loop of the actuator to a minimum gain value; and
after a predefined waiting time has expired, switching off the actuator of the at least one MEMS gyroscope and causing a natural decrease in a remaining oscillation amplitude of the oscillation of the oscillation element of the at least one MEMS gyroscope.

6. The method according to claim 5, wherein the predefined waiting time is dependent on a duration of time that is required to reduce the oscillation amplitude to a minimum amplitude value.

7. The method according to claim 1, wherein the interrupting of the actuation of the at least one MEMS gyroscope includes:
inverting an oscillation direction of an oscillation of an oscillation element of the at least one MEMS gyroscope by 180° by inverting drive signals from an actuator of the at least one MEMS gyroscope using a phase comparator of a control loop of the actuator of the at least one MEMS gyroscope; and
after a predefined waiting time has expired, switching off the actuator of the at least one MEMS gyroscope.

8. The method according to claim 7, wherein the predefined waiting time is dependent on a duration of time that is required to invert a phase of the oscillation of the oscillation element.

9. The method according to claim 8, wherein inverting the phase of the oscillation of the oscillation element of the at least one MEMS gyroscope from 0° to 180° is effected by integrating an inversion bit into a register of the phase comparator.

10. A device comprising:
a computing unit configured to operate a sensor system, including at least one MEMS gyroscope and at least one pressure sensor, by performing the following steps including:
receiving pressure sensor data from the at least one pressure sensor, wherein the pressure sensor data represent an ambient pressure of an environment of the sensor system,
ascertaining a pressure change in the ambient pressure based on the pressure sensor data, wherein the pressure change includes a predefined change profile,
ascertaining, based on the pressure change with the predefined change profile of the ambient pressure, that the sensor system is in a falling state, and
interrupting actuation of the at least one MEMS gyroscope.

11. A non-transitory storage medium on which is stored a computer program product including commands for operating a sensor system including at least one MEMS gyroscope and at least one pressure sensor, the commands, when executed by a data processor, causing the data processor to perform the following steps comprising:
receiving pressure sensor data from the at least one pressure sensor, wherein the pressure sensor data represent an ambient pressure of an environment of the sensor system;
ascertaining a pressure change in the ambient pressure based on the pressure sensor data, wherein the pressure change includes a predefined change profile;
ascertaining, based on the pressure change with the predefined change profile of the ambient pressure, that the sensor system is in a falling state; and
interrupting actuation of the at least one MEMS gyroscope.

12. A sensor system, comprising:
at least one pressure sensor;
at least one MEMS gyroscope; and
at least one computing unit configured to operate the sensor system by performing the following steps including:
receiving pressure sensor data from the at least one pressure sensor, wherein the pressure sensor data represent an ambient pressure of an environment of the sensor system,
ascertaining a pressure change in the ambient pressure based on the pressure sensor data, wherein the pressure change includes a predefined change profile,
ascertaining, based on the pressure change with the predefined change profile of the ambient pressure, that the sensor system is in a falling state, and
interrupting actuation of the at least one MEMS gyroscope.
